(19) United States
(12) Patent Application Publication
(10) Pub. No.: US 2009/0081507 A1
(43) Pub. Date: Mar. 26, 2009

(54) FUEL CELL SYSTEM

(76) Inventors: Ming-Zi Hong, Suwon-si (KR); Yasuki Yoshida, Suwon-si (KR); Ho-Jin Kweon, Suwon-si (KR)

Correspondence Address: CHRISTIE, PARKER & HALE, LLP, PO BOX 7068, PASADENA, CA, 91109-7068, US

(21) Appl. No.: 12/234,418

(22) Filed: Sep. 19, 2008

(30) Foreign Application Priority Data
Sep. 21, 2007 (KR) 10-2007-0096757

(51) Int. Cl. H01M 8/10; H01M 8/02

(52) U.S. Cl. 429/26; 429/30

(57) ABSTRACT

Disclosed is a methanol fuel cell system that utilizes solid methanol as a fuel. The fuel cell system according to the present invention includes a fuel cell stack for generating electricity through a chemical reaction of oxygen and hydrogen produced from solid methanol, a fuel supply tank containing solid methanol, and a recycle line that directs an effluent of the fuel cell stack back to the fuel supply tank.

### CROSS-REFERENCE TO RELATED APPLICATION

This application claims priority to and the benefit of Korean Patent Application No. 10-2007-0096757 filed on Sep. 21, 2007 in the Korean Intellectual Property Office, the entire content of which is incorporated herein by reference.

### BACKGROUND

1. Field of the Invention

The present invention relates to a fuel cell system using solid methanol.

2. Discussion of Related Art

In general, a fuel cell is a generator system for directly converting chemical energy into electrical energy through an electrochemical reaction of hydrogen and oxygen. Pure hydrogen may be directly supplied to a fuel cell system and/or hydrogen may be produced from raw materials such as methanol, ethanol, natural gas, etc. and supplied to a fuel cell system. Pure oxygen may be directly supplied to a fuel cell system and/or air can be used as a source of oxygen to supply oxygen to a fuel cell system using an air pump, etc.

There are several types of fuel cell. They include a polymer electrolyte fuel cell or a direct methanol fuel cell that can operate at room temperature or 100° C. or less. There are other types of fuel cell that operate at higher temperatures. Such fuel cells may include a phosphoric acid fuel cell that operates at a temperature range from 150 to 200° C., a molten carbonate fuel cell that operates at a temperature range from 600 to 700° C., a solid oxide fuel cell that operates at a temperature of 1000° C. or above, etc. Each of the fuel cells basically generates electricity in the same principle, but is different in the kinds of used fuels, catalysts, electrolytes, etc.

Among the fuel cells, the direct methanol fuel cell (DMFC) can directly use as a fuel a liquid phase of high concentration methanol with water instead of hydrogen. The direct methanol fuel cell has a lower output density than a fuel cell that directly uses hydrogen as a fuel, but has a high energy density per volume of methanol used as the fuel. Also, the DMFC can be manufactured on a smaller scale since there is no need for additional devices such as a reformer for reforming a fuel to generate hydrogen and since methanol can more easily be stored in a small space.

A typical DMFC includes an electrolyte membrane and a membrane electrolyte assembly (MEA) which is composed of an anode electrode and a cathode electrode arranged on opposite sides of the electrolyte membrane. Fluorinated polymers and the like are used as the electrolyte membrane. However fluorinated polymers frequently exhibit a crossover phenomenon, in which unreacted methanol permeates through the electrolyte membrane. The permeation of methanol occurs because of the excellent permeability of methanol when it is used at high concentrations. Accordingly, water is frequently mixed with methanol to reduce the concentration of methanol before it is introduced to a fuel cell stack.

Other type of fuel cells, such as polymer electrolyte membrane fuel cells (PEMFC) use hydrogen formed by reforming materials such as methanol, ethanol, natural gas, etc., and have excellent output characteristics. A PEMFC has a low operating temperature and rapid driving and response time compared to other fuel cells. Therefore, PEMFCs are widely used in the fields of automobile power sources, power sources for distribution to residential houses and public buildings, and power sources for portable electronic equipment.

A PEMFC operates by converting raw materials into a hydrogen-rich reformed gas used as the fuel for the fuel cell through a catalytic reaction such as steam reforming (SR) or water gas shift (WGS). Any carbon monoxide that is included in the reformed gas should be removed to prevent poisoning of the catalysts in the fuel cell. Since the catalytic reaction requires water, water is supplied to the fuel mixture by mixing water with a fuel that is fed to the reformer.

Since the configuration of a DMFC is simpler than that of a PEMFC, DMFC systems can be useful in power supply equipment for portable devices. However, the DMFC's portability can be limited because its electric generator capacity is relatively low as compared to the amount of consumed fuel. Also, it is difficult to use fluid methanol in portable devices because of its low stability at room temperature. Further, due to recent changes in security, fluid methanol is classified as a restricted chemical, which hinders the use of DMFC in portable devices.

### SUMMARY OF THE INVENTION

The present invention is related to a fuel cell system using solid methanol as a fuel. Throughout this Specification, the term “solid methanol,” also known as “solid-state methanol” refers to methanol that is carried as a guest compound on a solid state host or support compound.

An embodiment of the present invention is directed toward a fuel cell system that includes a fuel cell stack, a fuel supply tank, and a recycle line. The fuel supply tank includes an inner space that contains a solid fuel. The recycle line receives an effluent generated from the fuel cell stack and recycles the effluent to the fuel supply tank. In one embodiment, the solid fuel is solid methanol.

In one embodiment, the fuel cell system further includes a condenser to condense some of the effluent gas into a liquid. The condenser may include an air-cooled heat exchanging unit. In one embodiment, the heat exchanging unit is a coiled pipeline having a large surface area that is cooled by a cooling fan.

In one embodiment, the fuel cell system includes a feed pump for pumping an aqueous methanol solution stored in the fuel supply tank to the fuel cell stack. In another embodiment, the fuel cell system further includes an air pump for supplying fresh air to the cathode side of the fuel supply stack.

Another aspect of an embodiment of the present invention is directed toward a fuel cell system that includes a fuel cell stack; a water tank; and a fuel supply tank that has an inner space and a solid fuel disposed in the inner space. In an exemplary embodiment, the solid fuel is solid methanol. In one embodiment, the fuel cell system further includes a water pump for pumping water stored in the water tank to the fuel supply tank. In another embodiment, the fuel cell system further includes a fuel feed pump for pumping an aqueous methanol solution from the fuel feed tank to the fuel cell stack.

In another exemplary embodiment, the fuel cell stack has a recycle line connecting the fuel cell stack with the fuel supply tank.

In one exemplary embodiment, the fuel cell stack has a frame with air vent holes.

### BRIEF DESCRIPTION OF THE DRAWINGS

The present invention will now be described more fully with reference to the accompanying drawings, in which exemplary embodiments of the invention are shown.

FIG. 1A is a schematic diagram showing a configuration of a solid methanol fuel cell system according to one exemplary embodiment of the present invention.

FIG. 1B is a schematic configuration illustrating a modification of the fuel supply tank of FIG. 1A.

FIG. 2 is a schematic diagram showing a configuration of a solid methanol fuel cell system according to another exemplary embodiment of the present invention.

### DETAILED DESCRIPTION OF EXEMPLARY EMBODIMENTS

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, elements that are not essential to the complete understanding of the invention are omitted for clarity. Also, like reference numerals refer to like elements throughout.

For example, the phrase “fuel cell stack” as used in the description of the present invention can be considered as a typical fuel cell stack that includes one or more unit cells arranged in a stacked configuration.

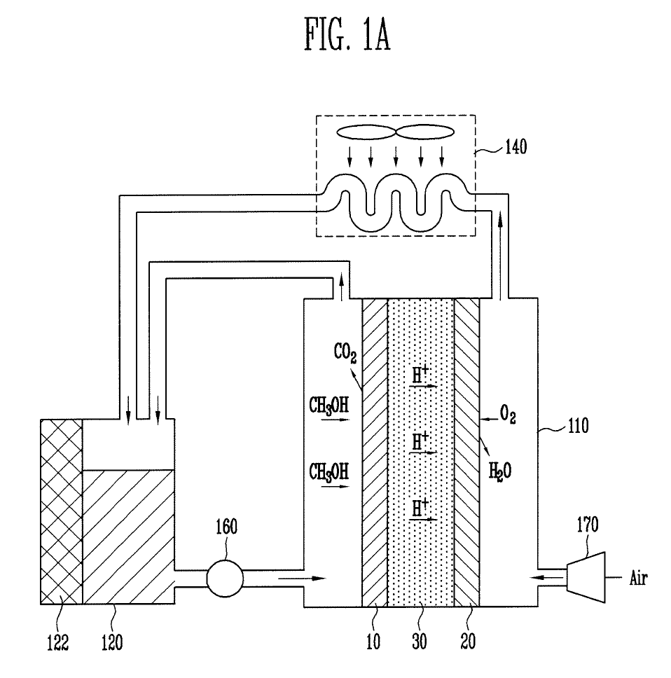

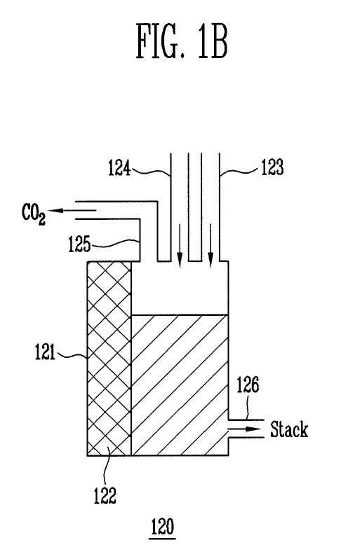

As shown in FIG. 1A, the fuel cell system according to an embodiment of the present invention includes a fuel cell stack 110 for generating electricity through chemical reactions of oxygen and hydrogen produced from methanol. A fuel supply tank 120 has an inner space containing solid methanol 122. A condenser 140 is provided for condensing an effluent from the cathode of the fuel cell stack 110, and a feed pump 160 is provided for supplying an aqueous methanol solution stored in the fuel supply tank 120 to the fuel cell stack 110. The fuel cell system may further include an air pump 170 for feeding air to the cathode of the fuel cell stack 110.

The fuel cell stack 110 may be a typical fuel cell stack used in conventional direct methanol fuel cell systems. Referring to the fuel cell stack 110 as shown in FIG. 1, a membrane electrolyte assembly (MEA) in a conventional DMFC is configured with an electrolyte membrane 30 disposed between an anode electrode 10 and a cathode electrode 20. Fuel, in this embodiment, a mixture of methanol (CH₃OH) and water (H₂O), is supplied to the anode electrode 10 and decomposed into carbon dioxide (CO₂), hydrogen ions (H⁺), and electrons (e⁻) by a catalyst.

The hydrogen ions move to the cathode electrode 20 through the electrolyte membrane 30, and the electrons move to the cathode electrode 20 through an external power circuit. Air is supplied to the cathode electrode 20 as the source of oxygen. At the cathode 20, the electrons and hydrogen ions produced at the anode electrode 10 react with oxygen on a catalyst to form water. The electrochemical reactions at the anode electrode 10 and the cathode electrode 20 are represented by the following Equation 1.

Anode electrode: CH₃OH+H₂O→CO₂+6H⁺+6e⁻ Equation 1

Cathode electrode: 3/2 O₂+6H⁺+6e⁻→3H₂O

Total: CH₃OH+3/2 O₂→CO₂+3H₂O

The fuel supply tank 120 has an inner space for collecting an anode effluent and a cathode effluent of the fuel cell stack 110 and includes solid methanol 122 provided on a solid methanol host or support material. When solid methanol 122 is soaked in water, the solid methanol releases methanol to form an aqueous methanol solution. In an embodiment, as shown in FIG. 1, the solid methanol 122 is affixed vertically in the fuel supply tank 120 and produces a constant concentration of aqueous methanol solution regardless of the amount of water contained in the fuel supply tank 120.

The feed pump 160 supplies the aqueous methanol solution stored in the fuel supply tank 120 to an anode of the fuel cell stack 110. The air pump 170 supplies the air as an oxidant to a cathode of the fuel cell stack 110.

In one exemplary embodiment, a condenser 140 is provided to condense an effluent gas discharged from the cathode of the fuel cell stack 110 into a liquid. In one embodiment, a DMFC system includes a heat exchanging unit that has a coiled pipeline with a large surface area to facilitate heat transfer from the cathode effluent. In this embodiment, a cooling fan is also included to further cool the heat exchanging unit with air, as shown in FIG. 1A.

The effluent from the cathode may include gas components containing CO₂ and fluid components containing unreacted methanol. Accordingly, a gas/liquid separator can be employed to separate and discharge the gas components and to route the fluid components back to the fuel supply tank 120. The gas/liquid separator may be provided at the condenser 140 or at the fuel supply tank 120.

FIG. 1B schematically shows a fuel supply tank 120. Referring to FIG. 1B, the fuel supply tank 120 includes a chamber 121 for storing a fluid, a cathode effluent inlet 124 for receiving a cathode effluent of the fuel cell stack 110, an anode effluent inlet 123 for receiving an anode effluent of the fuel cell stack 110, solid methanol 122 disposed in the chamber 121, a fuel outlet 126 for supplying an aqueous methanol solution to the fuel cell stack, and a gas outlet 125 for discharging out gases separated in the chamber 121.

In another, exemplary embodiment, the fuel supply tank 120 further includes a water inlet for introducing water to replenish the water used during the operation of the fuel cell system.

Initially, the fuel supply tank 120 should be filled with water as shown in FIG. 1A to a certain level that it is sufficient to supply the fuel to the fuel cell stack 110. During operation, the fuel supply tank 110 is replenished with the water generated from the cathode of the fuel cell stack 110 as it recycles back to the tank.

As the fuel supply tank 120 is initially filled with water, methanol elutes from the solid methanol 122, and mixes with the water to become an aqueous methanol solution. The feed pump 160 then begins to operate when the aqueous methanol solution in the fuel supply tank 120 reaches a predetermined concentration. The feed pump 160 supplies the aqueous methanol solution to the anode side of the fuel cell stack 110.

Generally, the aqueous methanol supplied to the anode electrode 10 of the fuel cell stack 110 decomposes into hydrogen ions and carbon dioxide. However, some of the aqueous methanol passes through the electrolyte membrane 30 due to the undesirable crossover phenomenon, and some of this methanol may be oxidized at the cathode electrode 20. A mixture of water vapor, CO₂, excess air, and methanol is discharged out of the fuel cell stack 110.

Initially, at the inlet to the condenser 140, the cathode effluent is heated and contains a large amount of gas discharged from the cathode of the fuel cell stack 110. As the effluent moves through the heat exchanging unit of the condenser 140, some of the gas condenses into a fluid containing methanol and water. At the outlet of condenser 140, the cathode effluent has a smaller amount of gas and a larger amount of fluid, which then flows to the fuel supply tank 120.

In one exemplary embodiment, excess methanol that is fed by the feed pump 160 to the fuel cell stack 110 flows back to the fuel supply tank 120 as a recycled methanol feed.

According to this embodiment, two recycle lines recycle effluent from the fuel cell stack 110 to the fuel supply tank 120. The first line comes from the anode 10 of the fuel supply stack 100 as discussed above and the second line comes from the cathode 20. The second line contains an effluent with a lower methanol concentration than the first line as it contains water and gaseous components such as CO₂.

The gaseous components in the recycle lines are spontaneously separated by gravity in the tank, and are discharged out through a gas outlet. Whereas, the fluid components consisting of unreacted methanol coming from the anode and the cathode and water generated at the cathode flow back to the fuel supply tank 120. As water generated at the fuel cell stack 110 flows back to the fuel supply tank 120 it dilutes the aqueous methanol solution resulting in a lowered methanol concentration.

As the methanol concentration of the aqueous solution in the fuel supply tank 120 is lowered, methanol continues to elute from the solid methanol 122 until an equilibrium concentration of methanol is reached. Therefore, the methanol concentration of the aqueous solution in the fuel supply tank 120 is constantly maintained and supplied to the fuel cell stack 110 to ensure a constant electricity generation.

When the methanol from solid methanol 122 is exhausted, the concentration of the aqueous methanol solution in the fuel supply tank 120 decreases. According to an embodiment, a suitable sensor is provided to determine that the methanol concentration is low, signaling an alarm to notify of a need for fuel replacement. The sensor can be installed in the fuel supply tank 120 or in the fuel cell stack 110. Similarly, a power output sensor can also be installed to detect a decrease in electricity generation to notify of a need for fuel replacement.

### Embodiment 2

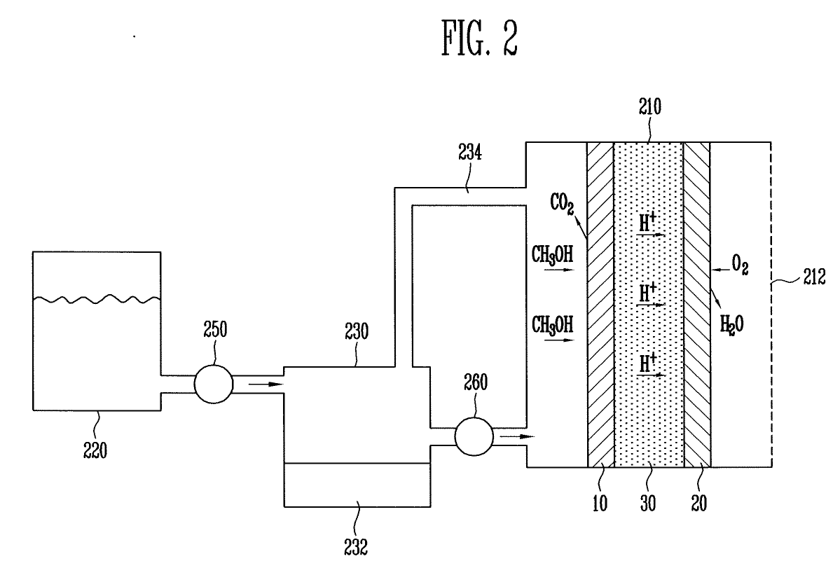

As shown in FIG. 2, the fuel cell system according to another embodiment of the present invention includes a fuel cell stack 210 for generating electricity, a water tank 220 for storing water, a fuel supply tank 230 for receiving water from the water tank 220 and for storing solid methanol 232, a water pump 250 for supplying water stored in the water tank 220 to the fuel supply tank 230, and a feed pump 260 for supplying an aqueous methanol solution stored in the fuel supply tank 230 to the fuel cell stack 110.

The fuel cell stack 210 of this exemplary embodiment can also be used in conventional DMFC systems, as well as in the previously described exemplary embodiments. With reference to FIG. 2, a simplified configuration of the fuel cell stack with a passive cathode 210 is shown. In this embodiment, oxygen is supplied by atmospheric air that passes through a frame having air vent holes 212. Water and CO₂ generated at the cathode are also discharged out by escaping through the air vent holes 212. As a result, there is no need for recovering water from the cathode since a separate water tank has already been provided in the exemplary embodiment. For this embodiment, loss of methanol must be replenished since any method for recovering methanol will increase the size of the system as a condenser and a mixing tank for recovering crossovered methanol would be needed.

According to a more simplified embodiment, the recovery pipe 234 connecting the anode area to the fuel supply tank 230 may be omitted. Similarly, the feed pump 260 may also be omitted to further simplifying the process.

The fuel supply tank 230 for this embodiment has an inner space containing water supplied from the water tank 220 and solid methanol 232 disposed in the inner space. In FIG. 2, the solid methanol 232 is disposed at the bottom of the fuel supply tank 230. In this arrangement, the size of the fuel supply tank 230 can be reduced while facilitating a fast methanol elution rate from the solid methanol 232.

The feed pump 260 supplies the aqueous methanol solution stored in the fuel supply tank 230 to the anode of the fuel cell stack 210. The water pump 250, in turn, supplies the fuel supply tank 220 with water to replenish some of the aqueous methanol solution used at the anode.

At the initial stage of the operation of the fuel cell system, only the water tank 220 is filled with water and only solid methanol 232 is present in the fuel supply tank 230. At this stage, the security risk is lessened as liquid methanol, which is classified as a hazardous material, is not present in the system.

To operate the fuel cell system, the water pump 250 is turned on to supply the fuel supply tank 230 with water. Once the fuel supply tank 230 contains sufficient water, methanol elutes from the solid methanol 232. As the methanol elutes and mixes with the water in the fuel supply tank 230, an aqueous methanol solution is formed. Then, the feed pump 260 begins to operate to supply the aqueous methanol solution fuel to the anode of the fuel cell stack 210.

The methanol supplied in an aqueous state to the anode electrode 10 of the fuel cell stack 110 decomposes into hydrogen ions and carbon dioxide. Some of the methanol passes through the electrolyte membrane 30 and oxidizes at the cathode electrode 20. The water vapor and any crossover methanol are then discharged out through the frame having vent holes 212.

In an exemplary embodiment, a suitable sensor is installed to detect changes in the methanol concentration. The sensor can be installed in the fuel supply tank 230, the fuel cell stack 210, or the fuel supply line between the fuel supply tank 230 and the fuel cell stack 210. Similarly a sensor to detect changes in the electricity output generated by the fuel cell stack 210 can also be installed to notify when a replenishment of fuel is needed.

The fuel cell system using solid methanol as a fuel according to the exemplary embodiments of the present invention can also be used in conventional direct methanol fuel cells with minor modifications.

Also, the fuel cell system according to the present invention may be useful to prevent fuel leakage when the fuel cell system is not used for a long time, and/or to prevent fires caused by the combustion of fuel.

Although exemplary embodiments of the present invention have been illustrated and described, it would be appreciated by those skilled in the art that various modification and changes might be made in these embodiments without departing from the principles and spirit of the invention, which is further defined by the following claims and their equivalents.

What is claimed is:

1. A fuel cell system, comprising:
a fuel cell stack;
a fuel supply tank adapted to contain a solid fuel and an aqueous fuel solution; and
an effluent recycle line from the fuel cell stack to the fuel supply tank.

2. The fuel cell system according to claim 1, further comprising a condenser through which the effluent recycle line passes.

3. The fuel cell system according to claim 1, further comprising a feed pump adapted to feed the aqueous fuel solution from the fuel supply tank to the fuel cell stack.

4. The fuel cell system according to claim 1, further comprising an air pump adapted to supply air to the fuel cell stack.

5. The fuel cell system according to claim 2, wherein the condenser comprises a heat exchanging unit and a fan.

6. The fuel cell system according to claim 5, wherein the heat exchanging unit comprises a coiled pipeline.

7. The fuel cell system according to claim 1, wherein the solid fuel is solid methanol.

8. A fuel cell system, comprising:
a fuel cell stack adapted to generate electricity through a chemical reaction of hydrogen and oxygen; and
a fuel supply tank including a solid fuel and adapted to store an aqueous fuel solution; and
a water tank.

9. The fuel cell system according to claim 8, further comprising a water pump adapted to supply water to the fuel supply tank.

10. The fuel cell system according to claim 8, further comprising a feed pump adapted to supply the aqueous fuel solution to the fuel cell stack.

11. The fuel cell system according to claim 8, wherein the fuel cell stack further comprises at least one air vent hole adapted to supply air to the fuel cell stack.

12. The fuel cell system according to claim 8, wherein the solid fuel is solid methanol.
